(19) United States
(12) Patent Application Publication
(10) Pub. No.: US 2012/0247885 A1
(43) Pub. Date: Oct. 4, 2012

(54) Adaptive Torque Plates

(75) Inventors: Richard L. LANTZ, Clinton, OH (US); Ronald S. Plantan, Elyria, OH (US); Ken E. Scheckelhoff, Elyria, OH (US); Lonnie F. Cool, North Olmsted, OH (US)

(73) Assignee: Bendix Spicer Foundation Brake LLC, Elyria, OH (US)

(21) Appl. No.: 13/077,188

(22) Filed: Mar. 31, 2011

(51) Int. Cl. F16D 65/00; B26D 3/00

(52) U.S. Cl. 188/205 R; 83/13

(57) ABSTRACT

An arrangement for securing a carrier for a brake to an axle housing of a vehicle includes a torque plate having an attachment portion securable to the carrier and an annular mounting section securable to a backing plate on the axle housing. The annular mounting section is provided with pluralities of alignment holes and mounting slots, permitting adjustment of a torque plate clocking angle. By way of a torque plate configured in accordance with this invention, clocking angle adjustments can be made in increments of under three degrees.

### BACKGROUND OF THE INVENTION

1. Field of the Invention

This invention concerns a torque plate securable to a backing plate secured in conventional fashion to a vehicle axle housing. Although it is not limited to such applications, the invention is particularly suitable for use in conjunction with air disc brakes.

2. Description of Related Art

U.S. Pat. No. 1,222,929 to Campbell discloses a brake assembly with adjustable sleeves on a spider. By way of four pins, twelve pin holes in adjustable disks of respective sleeves and sixteen pin holes in associated keyed disks mate to allow various brake assembly orientations.

U.S. Pat. No. 4,047,598 to Thrower concerns a torque plate configured to shift brake torque to a non-rotating support member so that the torque plate can be made thinner. The torque plate includes slots and support surfaces to transfer torque and decrease the weight of the torque plate. The thinness of the torque plate and the slots in the torque plate allow more space for the brake itself.

U.S. Pat. No. 4,311,216 to Garrett et al. relates to a torque plate that provides both a large surface mounting area and a gap between the plate and the rotor for cooling. The Garrett et al. torque plate includes a hole in its mounting providing for sliding over the axle and additional cooling when the plate is against the flange.

U.S. Patent Application Publication 2006/0237267 to Brown, II, et al. shows a torque plate with a longitudinally-oriented fastener, which is accessible for mounting of the disc brake assembly.

For air disc brake applications, disc brake assemblies are typically attached to axle flanges using torque plates, while for drum brake applications, brake spiders are typically used to attach drum brake assemblies to axle flanges. In air disc brake applications, to accommodate all clocking arrangements needed to position the air disc brake assemblies, the torque plates are manufactured in many configurations, with different part numbers, but with mounting bolt circle patterns that differ only slightly. These numerous torque plate configurations are presently used to provide all of the clocking angles needed to clear original equipment manufacturer (OEM) offered axle and suspension combinations with which the disc brake assemblies are used.

### SUMMARY OF THE INVENTION

The designs disclosed here permit the use of very few torque plates to accommodate all air disc brake assembly clocking angles needed for most of the drive and steer axle and suspension combinations offered by major OEM truck manufacturers.

According to the invention, an advantageous arrangement for securing a carrier for a brake to an axle housing of a vehicle is provided. This arrangement includes a torque plate having an attachment portion securable to the carrier and an annular mounting section securable to a backing plate on the axle housing. The annular mounting section is provided with pluralities of alignment holes, which may be circular, and elongated mounting slots, permitting adjustment of a torque plate clocking angle. An ABS sensor mounting arrangement may be mounted in one of the slots. By way of a torque plate configured in accordance with this invention, clocking angle adjustments can be made in increments of below three degrees.

The torque plate is intended to constitute one of a plurality of interchangeable torque plates providing for adjustment of the clocking angle. In one of the embodiments disclosed, four individual and interchangeable torque plates are utilized to permit clocking angle adjustments from zero degrees to 360 degrees relative to the backing plate. In another embodiment, no more than two such interchangeable torque plates are utilized to permit the same clocking angle adjustments. Bolts or similar fasteners are used to fasten each torque plate to the backing plate. A maximum of ten such bolts are needed to adequately fasten the torque plate to the backing plate.

In one embodiment of the invention, two pairs of alignment holes are provided, with each alignment hole having a center circumferentially offset from the center of an adjacent alignment hole by an angle exceeding 22.5 degrees. The specifically preferred angle in this particular embodiment would be 25.31 degrees of offset. Adjacent alignment holes are directly adjacent to each other with no slots interposed in this embodiment.

In another embodiment of the invention, four pairs of alignment holes are provided, and each alignment hole has a center circumferentially offset from the center of an adjacent alignment hole by an angle below 45 degrees. The specifically preferred angle in this other embodiment would be 42.19 degrees. All adjacent alignment holes have a mounting slot disposed therebetween in this embodiment.

As will become clear, the present invention uses slots and holes to allow clocking of the air disc brake assembly at 2.81 degree intervals with respect to the axle flange, and solves problems associated with mounting the brakes at different orientations to improve brake access and limit interference. A mathematical relationship between holes and slot locations permits finer clocking intervals for more orientation options. Production of cast torque plates can continue; only the secondary step of machining the torque plates is changed.

### BRIEF DESCRIPTION OF THE DRAWINGS

FIG. 1 is a plan view of a first torque plate used in accordance with a first embodiment of the invention.

FIG. 2 is a view similar to FIG. 1 but showing the first torque plate mounted by way of different alignment holes.

FIG. 3 is a plan view similar to that of FIG. 1, but of a second torque plate used in the first embodiment.

FIG. 4 is a view similar to that of FIG. 2 showing the second torque plate mounted by way of the different alignment holes.

FIG. 5 is FIG. 3 is a plan view similar to that of FIG. 1, but of a third torque plate used in the first embodiment.

FIG. 6 is a view similar to that of FIG. 2 showing the third torque plate mounted by way of the different alignment holes.

FIG. 7 is a plan view similar to that of FIG. 1, but of a fourth torque plate used in the first embodiment.

FIG. 8 is a view similar to that of FIG. 2 showing the fourth torque plate mounted by way of the different alignment holes.

FIG. 9 is a part-sectional view along line 9-9 of FIG. 1.

FIG. 10 is an enlarged view of an identified portion of FIG. 9.

FIG. 11 is a perspective view of the second torque plate used in the first embodiment with an ABS sensor mounting arrangement received in a slot.

FIG. 12 is a plan view of a first torque plate used in accordance with a second embodiment of the invention.

FIG. 13 is a plan view similar to that of FIG. 12, but of a second torque plate used in the second embodiment.

FIG. 14 is a part-sectional view along line 14-14 of FIG. 12.

FIG. 15 is a view of the second torque plate shown in FIG. 13 after it has been fully mounted to and secured upon an axle housing backing plate.

FIG. 16 is a sectional view along line 16-16 of FIG. 1.

### DETAILED DESCRIPTION OF THE INVENTION

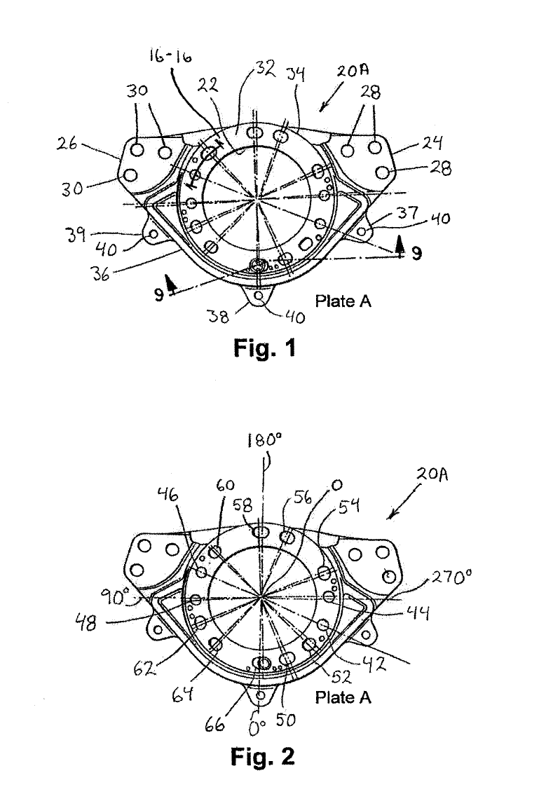

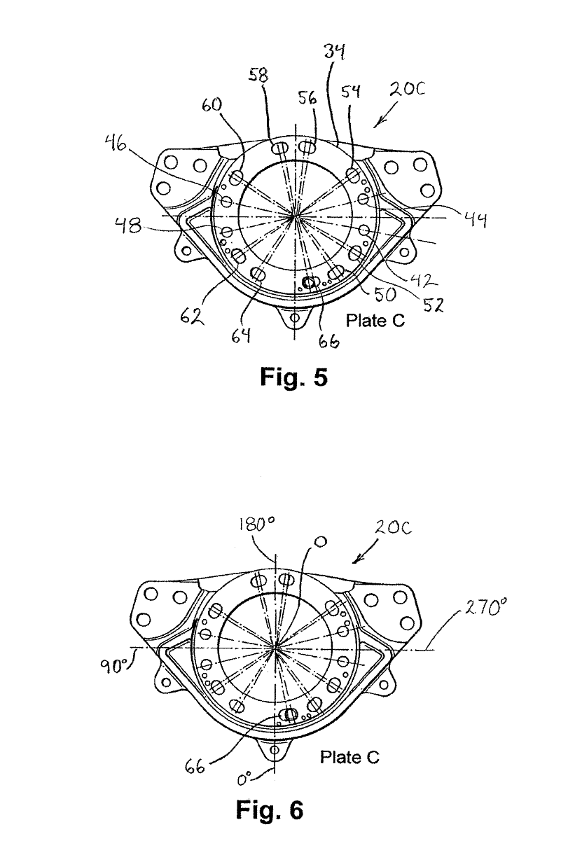

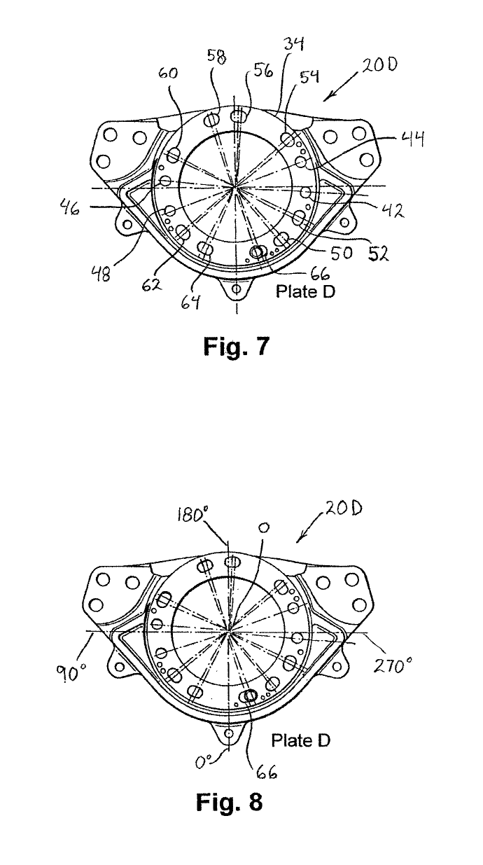

A first embodiment of the invention is shown in FIGS. 1-11. Referring initially to FIG. 1, a torque plate 20A is illustrated as having an annular mounting section 34 with a front face 32. The annular mounting section 34 of the torque plate 20A surrounds a central opening 22. The torque plate 20A includes pair of ears 24, 26 defined thereon, by way of which the torque plate 20A is mountable to a frame or carrier (not shown) for a disc brake caliper (also not shown). The ear 24 is provided with a plurality of holes 28 through which bolts may pass to secure the ear 24 to the mounting frame or carrier. The ear 26, similarly, includes a plurality of holes 30 for the same purpose. The torque plate 20A also defines a reinforcing flange 36 to improve torque plate stiffness, and tabs 37, 38, and 39, each having a hole 40 defined therein, distributed about an edge of the torque plate 20A between the ears 24 and 26.

While the present invention is shown and described in connection with torque plate arrangements using bolts that are to pass through the holes 28, 30 in directions approximately parallel to the longitudinal axis of the vehicle axle, it is to be understood that the invention is equally applicable to arrangements such as that disclosed by U.S. Patent Application Publication 2006/0237267 to Brown, II, et al. mentioned above, in which the attachment bolts are to pass through holes having axes oriented essentially perpendicular to the longitudinal vehicle axis.

By way of the annular mounting section 34, the torque plate 20A is securable to a backing plate secured in conventional fashion to a vehicle axle housing. It is contemplated that, in the context of the present invention, such a backing plate will include a mounting face aligning with the rear face of the annular mounting section 34, and that the backing plate on the axle housing will include 16 holes at regular 22.5° intervals distributed circumferentially around its mounting face. Mounting holes and slots distributed about the torque plate mounting section 34 will cooperate with the 16 regularly distributed axle housing backing plate holes in a manner to be described. It is also conceivable to provide the 16 regularly distributed holes at 22.5° intervals in the torque plate mounting section 34 and to have the mounting hole and slot configuration to be described provided in the axle housing backing plate. When the torque plate 20A is mounted to an associated vehicle, of course, a vehicle axle protrudes through the opening 22.

The torque plate 20A shown FIGS. 1 and 2 constitutes one of four interchangeable torque plates 20A, 20B, 20C, and 20D illustrated in FIGS. 1-9 and 11 that are usable to accommodate all air disc brake assembly clocking angles needed for most axle and suspension combinations offered by major OEM produced trucks. The mounting holes distributed about the annular mounting section 34 of the torque plate 20A will now be described with reference to FIG. 2 in conjunction with FIG. 1.

The annular mounting section 34 of the torque plate 20A is provided with four circular alignment holes 42, 44, 46, and 48, and nine oblong slots 50, 52, 54, 56, 58, 60, 62, 64, and 66. These four holes and nine slots are all aligned on a circular path, but are not disposed at regular intervals about that path. Each of the circular holes 42, 44, 46, and 48 has, disposed adjacent thereto, indicia in the form of either a mark “o” or a mark “oo.” These marks are utilized to facilitate torque plate orientation in a manner that which will be discussed.

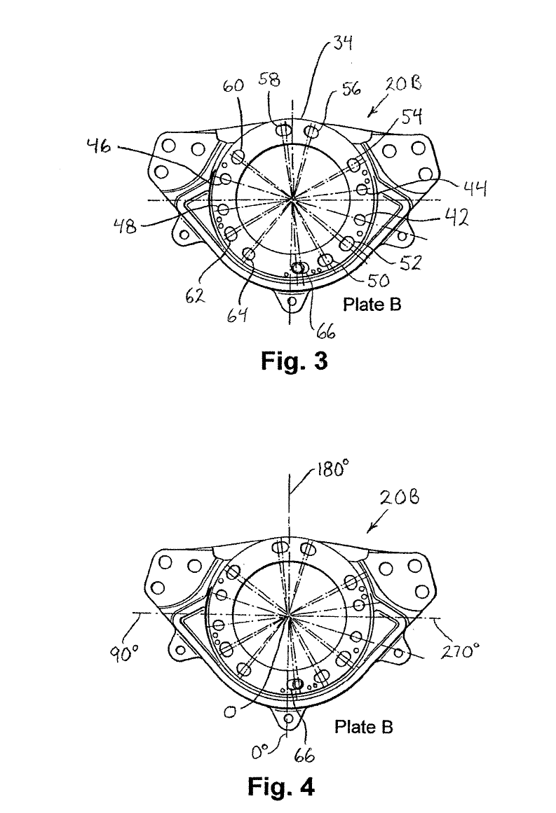

Essentially identical hole and slot arrangements are included in each of the other torque plates 20B, 20C, and 20D that are interchangeable with the torque plate 20A. More precisely, the hole and slot pattern for each of the torque plates 20A, 20B, 20C, and 20D is the same, except that the holes and slots of each pattern are angularly displaced about the circumferential path on which they lie by particular amounts relative to those of the other patterns. Thus, referring to FIGS. 3-8, each annular mounting section 34 of the torque plates 20B, 20C, and 20D also has four circular holes 42, 44, 46, and 48 and nine oblong slots 50, 52, 54, 56, 58, 60, 62, 64, and 66 provided therein, again with the four holes and nine slots of each torque plate aligned on a circular path but not disposed at regular intervals about that path.

The hole and slot arrangement in the mounting section 34 of the torque plate 20A, evident in FIGS. 1-2, will now be described. Considering the center O of the opening 22 in each torque plate to define the pole of a polar coordinate system, a ray passing from the center O through the center of the hole 40 in the central tab 38 will be defined as the polar axis. To produce a clocking angle defined as 0.00° with the torque plate 20A, alignment bolts are passed through the “o-” marked circular holes 42 and 46, which are located diametrically opposite to each other with respect to the central opening 22, and at the same time through two of the 16 regularly distributed holes in the axle housing backing plate that align or most closely align with the circular holes 42 and 46. The hole 46 in torque plate 20A has its center located at a polar angle of 112.5° (clockwise) from the polar axis as defined above, while the hole 42 has its center located at a polar angle of 292.5° from the polar axis.

The center of the circular hole 42 is disposed at a polar angle of 25.31° beyond the center of the circular hole 44, while the center of the circular hole 46 is similarly disposed at a polar angle of 25.31° beyond the center of the circular hole 48. As the 16 regularly distributed holes in the axle housing backing plate are disposed at regular 22.5° intervals, and the “oo-” marked holes are disposed at 25.31° relative to the “o-” marked holes, passing alignment bolts through the “oo-” marked circular holes 44 and 48 and two of the 16 regularly distributed backing plate holes rather than through the “o-” marked circular holes 42 and 46 and two of the 16 backing plate holes will produce torque plate clocking in the amount of (25.31°−22.5°), or 2.81°. Accordingly, to produce clocking of 2.81° with the torque plate 20A configuration, alignment bolts are passed through the “oo-” marked circular holes 44 and 48, which are also located diametrically opposite to each other with respect to the central opening 22, and through two of the 16 regularly distributed holes in the axle housing backing plate that align or most closely align with the circular holes 44 and 48.

The “o-” and “oo-” marked circular hole pairs 42, 46 and 44, 48 in each of the other torque plates 20B, 20C, and 20D are also disposed at 25.31° relative to each other, and also cooperate together with the backing plate holes to produce torque plate clocking in the amount of) (25.31°−22.5°, or 2.81°. However, each of the circular holes in the torque plates 20B, 20C, and 20D is displaced through a selected polar angle relative to the corresponding circular hole in the torque plate 20A. As noted above, the hole 46 in torque plate 20A has its center located at a polar angle of 112.5° (clockwise) from the polar axis as defined above, while the hole 42 has its center located at a polar angle of 292.5° from the polar axis. By comparison, the hole 46 in torque plate 20B has its center located at a polar angle of 106.9° (clockwise) from the polar axis, while the hole 42 in torque plate 20B has its center located at a polar angle of 286.9° from the polar axis. In similar fashion, the hole 46 in torque plate 20C has its center located at a polar angle of 101.3° (clockwise) from the polar axis as defined above, while the hole 42 in torque plate 20C has its center located at a polar angle of 281.3°. Finally, the hole 46 in torque plate 20D has its center located at a polar angle of 95.6° (clockwise) from the polar axis as defined above, while the hole 42 in torque plate 20D has its center located at a polar angle of 275.6° from the polar axis. Slots in each of the torque plates 20A, 20B, 20C, and 20D will have centers angularly displaced in the same amounts from the centers of corresponding slots in the other torque plates.

Attention is now directed to the following table.

| Torque | | Torque | | Torque | | Torque | |
|---|---|---|---|---|---|---|---|
| Plate | | Plate | | Plate | | Plate | |
| 20A | | 20B | | 20C | | 20D | |
| Clock- | | Clock- | | Clock- | | Clock- | |
| ing | | ing | | ing | | ing | |
| Angle | Mark | Angle | Mark | Angle | Mark | Angle | Mark |
| 0.00° | o | 5.63° | o | 11.25° | o | 16.88° | o |
| 2.81° | oo | 8.44° | oo | 14.06° | oo | 19.69° | oo |
| 22.50° | o | 28.13° | o | 33.75° | o | 39.38° | o |
| 25.31° | oo | 30.94° | oo | 36.56° | oo | 42.19° | oo |
| 45.00° | o | 50.63° | o | 56.25° | o | 61.88° | o |
| 47.81° | oo | 53.44° | oo | 59.06° | oo | 64.69° | oo |
| 67.50° | o | 73.13° | o | 78.75° | o | 84.38° | o |
| 70.31° | oo | 75.94° | oo | 81.56° | oo | 87.19° | oo |
| 90.00° | o | 95.63° | o | 101.25° | o | 106.88° | o |
| 92.81° | oo | 98.44° | oo | 104.06° | oo | 109.69° | oo |
| 112.50° | o | 118.13° | o | 123.75° | o | 129.38° | o |
| 115.31° | oo | 120.94° | oo | 126.56° | oo | 132.19° | oo |
| 135.00° | o | 140.63° | o | 146.25° | o | 151.88° | o |
| 137.81° | oo | 143.44° | oo | 149.06° | oo | 154.69° | oo |
| 157.50° | o | 163.13° | o | 168.75° | o | 174.38° | o |
| 160.31° | oo | 165.94° | oo | 171.56° | oo | 177.19° | oo |
| 180.00° | o | 185.63° | o | 191.25° | o | 196.88° | o |
| 182.81° | oo | 188.44° | oo | 194.06° | oo | 199.69° | oo |
| 202.50° | o | 208.13° | o | 213.75° | o | 219.38° | o |
| 205.31° | oo | 210.94° | oo | 216.56° | oo | 222.19° | oo |
| 225.00° | o | 230.63° | o | 236.25° | o | 241.88° | o |
| 227.81° | oo | 233.44° | oo | 239.06° | oo | 244.69° | oo |
| 247.50° | o | 253.13° | o | 258.75° | o | 264.38° | o |
| 250.31° | oo | 255.94° | oo | 261.56° | oo | 267.19° | oo |
| 270.00° | o | 275.63° | o | 281.25° | o | 286.88° | o |
| 272.81° | oo | 278.44° | oo | 284.06° | oo | 289.69° | oo |
| 292.50° | o | 298.13° | o | 303.75° | o | 309.38° | o |
| 295.31° | oo | 300.94° | oo | 306.56° | oo | 312.19° | oo |
| 315.00° | o | 320.63° | o | 326.25° | o | 331.88° | o |
| 317.81° | oo | 323.44° | oo | 329.06° | oo | 334.69° | oo |
| 337.50° | o | 343.13° | o | 348.75° | o | 354.38° | o |
| 340.31° | oo | 345.94° | oo | 351.56° | oo | 357.19° | oo |

In this table, the column on the left identifies the clocking angles produced when alignment bolts are inserted alternatively into the “o-” and “oo-” marked circular hole pairs 42, 46 and 44, 48 of the torque plate 20A and through pairs of the 16 regularly distributed holes in the axle housing backing plate that most closely align with the “o-” and “oo-” marked circular holes of the torque plate 20A. The second column from the left identifies the clocking angles produced when alignment bolts are inserted alternatively into the “o-” and “oo-” marked circular hole pairs 42, 46 and 44, 48 of the torque plate 20B and, again, through pairs of the 16 regularly distributed holes in the axle housing backing plate that most closely align with the “o-” and “oo-” marked circular holes of the torque plate 20B. The third column from the left identifies analogous clocking angles for the torque plate 20C, and the rightmost column identifies analogous clocking angles for the torque plate 20D. By passing torque plate alignment bolts through either the “o-” marked circular holes 42 and 46 or the “oo-” marked circular holes 44 and 48 of every torque plate 20A, 20B, 20C, and 20D as well as through respectively aligned pairs of the backing plate holes, torque plate clocking through an entire 360° range, in 2.81° intervals, can be obtained.

After selection of the appropriate torque plate and obtaining an appropriate clocking angle by fastening two of the alignment bolts in place, additional mounting bolts are utilized to secure the torque plate and the backing plate together. Although one of the oblong slots 66 in each torque plate 20A-20D is adapted to receive an anti-lock braking system (ABS) sensor mounting arrangement, the remaining eight oblong slots 50, 52, 54, 56, 58, 60, 62, and 64 are to be dimensioned and positioned so that each oblong slot aligns with at least one of the 14 remaining regularly distributed holes in the axle housing backing plate. Ten bolts, including the two alignment bolts and eight of the mounting bolts mentioned, are thus used to secure the torque plate to the backing plate on the axle housing. Although the alignment bolts and the mounting bolts noted are identified by different names, it is contemplated that bolts of a single type may be used as both alignment bolts and mounting bolts.

Every slot, except the slot 66, which receives the ABS sensor mounting arrangement, is to be provided with a mounting bolt. The circular holes 42, 44, 46, and 48 are best located in portions of the mounting section 34 that are to be subjected to relatively low stresses. The angular positions of the oblong slot centerlines could vary, depending primarily on the major (circumferential) dimension of the slots. Slots of varying dimensions and/or shapes could be utilized.

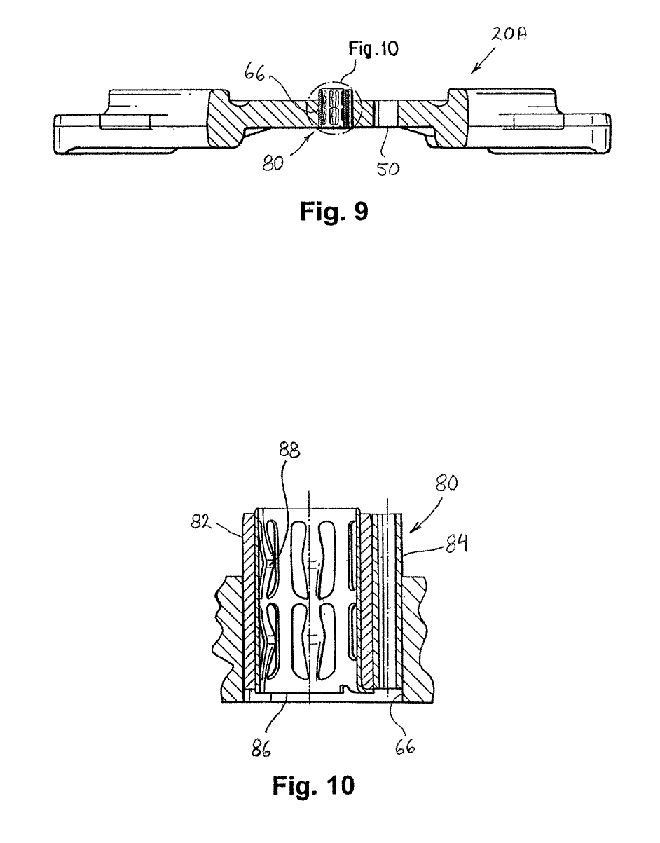

FIG. 9 is a part-sectional view along line 9-9 of FIG. 1, and illustrates an ABS sensor mounting arrangement 80 received in the oblong slot 66 of the torque plate 20A. FIG. 10 is an enlarged view of the identified portion of FIG. 9. As best seen in FIG. 10, the arrangement 80 is formed by an annular or cylindrical sleeve 82 of steel or other relatively rigid material. It is contemplated that, upon insertion of the sleeve 82 into the slot 66, for retention purposes, a split annular spring pin 84 will be deformed, and will operate to press the sleeve 82 against an end wall of the slot 66 to help retain the sleeve 82 within the slot 66. A slit, perforated, or otherwise formed ABS sensor clamping spring sleeve 86, having fingers with contact sections 88 designed to frictionally engage or interlock with corresponding portions of an ABS sensor, is retained within the sleeve 82. FIG. 11 shows the torque plate 20B with the ABS sensor mounting arrangement 80 received in its oblong slot 66 prior to securing the torque plate 20B to an axle housing backing plate. It will be seen from a comparison of FIGS. 1, 3, 5, and 7 with FIGS. 2, 4, 6, and 8 that the spring pin 84 may be used to press the sleeve against either end wall of the slot 66 as desired. A “clamping sleeve only” arrangement can alternatively be configured to retain the ABS sensor in position.

It will be understood from the foregoing discussion that one hundred twenty eight possibly appropriate torque plate clocking positions, separated from each other by 2.81°, may be obtained by appropriate use of only four torque plates 20A-20D in the manner described.

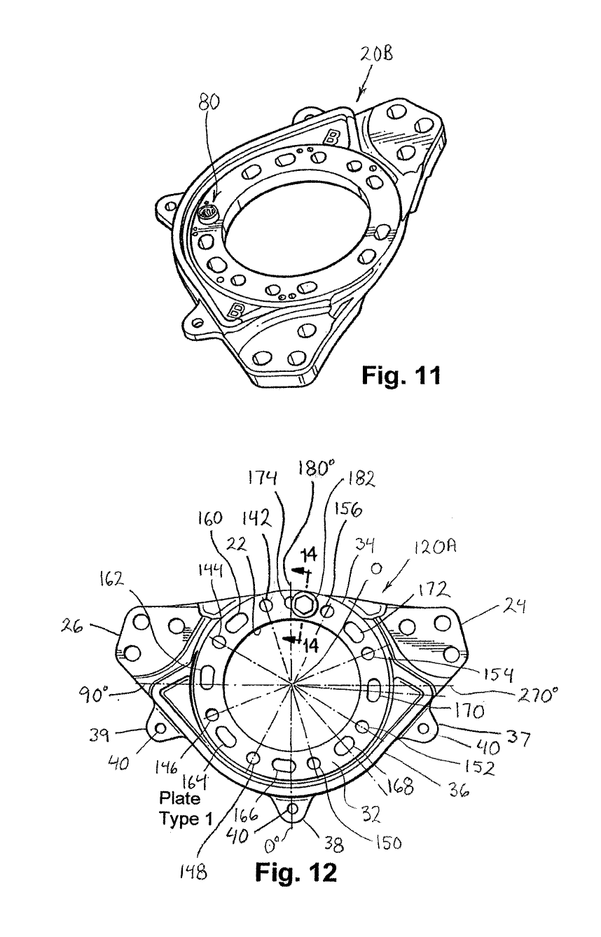

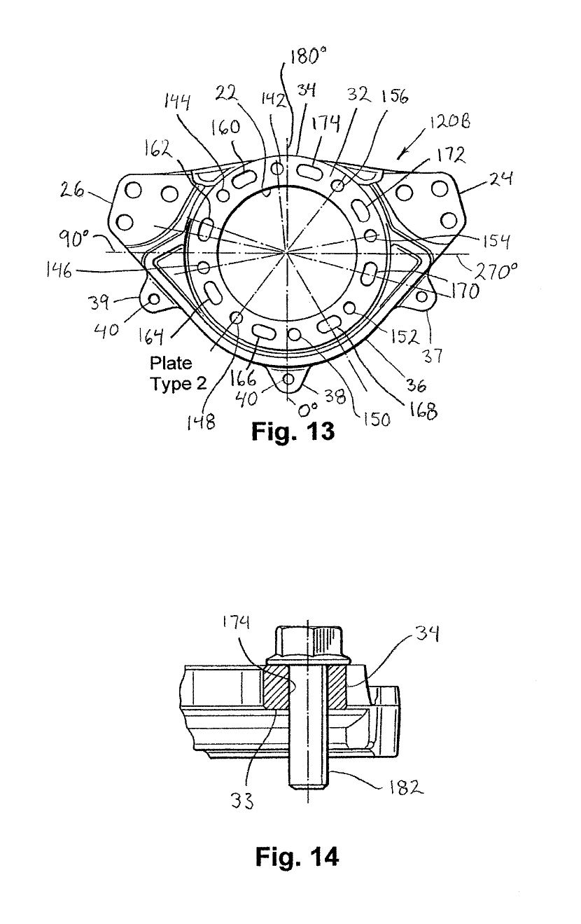

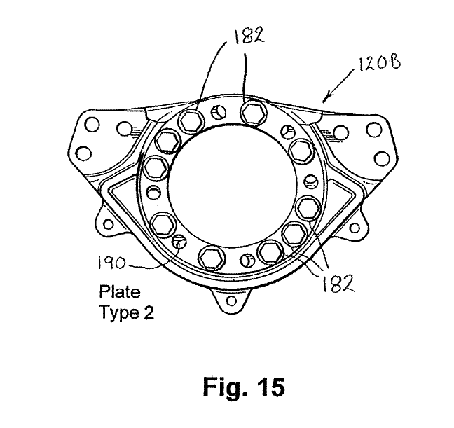

FIGS. 12-15 show a second embodiment of the invention, in which fewer separate torque plates are utilized. In this embodiment, two torque plates, identical except for mounting hole and slot locations, are used. One such torque plate 120A, identified as “Type 1,” is shown in FIG. 12, while the other torque plate 120B, identified as “Type 2,” is shown in FIGS. 13 and 15. As with the first embodiment of the invention, each of the torque plates 120A and 120B includes an annular mounting section 34 with a front face 32. The annular mounting section 34 of each torque plate of the second embodiment surrounds a central opening 22, and each of these torque plates includes pair of ears 24, 26, with holes for bolts, by way of which that torque plate is mountable to a frame or carrier (not shown) for a disc brake caliper (also not shown). Each torque plate 120A, 120B also defines a reinforcing flange 36 to improve torque plate stiffness, and tabs 37, 38, and 39, each having a hole 40 defined therein, distributed about an edge of the torque plate 20A between the ears 24 and 26.

As in the first embodiment, by way of the annular mounting sections 34, the torque plates 120A and 120B are securable to a backing plate formed together with or secured in conventional fashion to a vehicle axle housing. Such a backing plate will include a mounting face aligning with the rear face of the annular mounting section 34 and 16 holes at regular 22.5° intervals distributed circumferentially around its mounting face. The mounting holes and slots distributed about the torque plate mounting sections 34 will cooperate with the 16 regularly distributed axle housing backing plate holes in a manner that will be described presently.

The second (Type 2) torque plate 120B has its mounting holes and slots indexed by 11.25° when compared to the first (Type 1) torque plate 120A. The torque plates may be provided with appropriate indicia to facilitate their orientation. These two torque plates 120A and 120B, each with respective mounting hole and slot configurations, when mated with the axle flange bolt hole pattern, will allow a typical air disc brake assembly to be clocked in 2.81° intervals. Each of the torque plates will include 4 pairs of alignment holes, with holes in each pair disposed diametrically opposite to each other with respect to the central opening 22.

For the purposes of this discussion, the pair of holes 142, 150 in the first torque plate 120A will be identified as hole set A, the pair of holes 144, 152 in the first torque plate 120A will be identified as hole set B, the pair of holes 146, 154 in the first torque plate 120A will be identified as hole set C, and the pair of holes 148, 156 in the first torque plate 120A will be identified as hole set D. In a similar manner, the pair of holes 142, 150 in the second torque plate 120B will be identified as hole set E, the pair of holes 144, 152 in the second torque plate 120B will be identified as hole set F, the pair of holes 146, 154 in the second torque plate 120B will be identified as hole set G, and the pair of holes 148, 156 in the second torque plate 120B will be identified as hole set H.

Considering the center O of the opening 22 in each torque plate 120A, 120B to define the pole of a polar coordinate system, a ray passing from the center O through the center of the hole 40 in the central tab 38 will be defined as the polar axis. For the torque plate 120A, the centers of the holes 142 and 150 (hole set A) are respectively disposed at polar angles of 157.5° and 337.5° from the polar axis. Viewing FIG. 12, the centers of each of the remaining hole sets B, C, and D in the torque plate 120A are circumferentially displaced counterclockwise with respect to the centers of hole set A in increments of 42.19°. Thus, the centers of hole set B (the pair of holes 144, 152 in the first torque plate 120A) are disposed at polar angles of 115.31° and 295.31° from the polar axis, the centers of hole set C are disposed at polar angles of 73.12° and 253.12°, and the centers of hole set D are disposed at 30.93° and 210.93°.

For the torque plate 120B, the centers of the holes 142 and 150 (hole set E) are respectively disposed at polar angles of 168.75° and 348.75° from the polar axis. Viewing FIG. 13, the centers of each of the remaining hole sets F, G, and H in the torque plate 120B are circumferentially displaced counterclockwise with respect to the centers of hole set E in increments of 42.19°. Thus, the centers of hole set F (the pair of holes 144, 152 in the second torque plate 120B) are disposed at polar angles of 126.56° and 306.56° from the polar axis, the centers of hole set G are disposed at polar angles of 84.37° and 264.37°, and the centers of hole set H are disposed at 42.18° and 222.18°.

The annular mounting section 34 of each of the torque plates 120A and 120B also has eight slots 160, 162, 164, 166, 168, 170, 172, and 174 provided therein. The eight slots 160, 162, 164, 166, 168, 170, 172, and 174 are equally spaced about the mounting section 34, so that polar angles of 45° are present between slot centerlines. In contrast to the slots of the first embodiment, each slot in this second embodiment is disposed between adjacent circular holes. As in the first embodiment, the major (circumferential) dimension of the oblong slots could vary, and slots of varying dimensions and/or shapes could be utilized. Again, however, slots in the torque plate 120A will have centers angularly displaced in the same amounts from the centers of corresponding slots in the torque plate 120B.

To secure the torque plate 120A to the backing plate of a vehicle axle housing at a clocking angle that by definition is 0.00°, two bolts may be inserted through each hole of one of the alignment hole sets, such as the hole set A (holes 142 and 150), as well as through an aligned pair of the 16 backing plate holes spaced at regular 22.5° intervals. Torque plate attachment is completed by installing eight other mounting bolts and washers to be used through the slots 160, 162, 164, 166, 168, 170, 172, and 174, and applying torque to the nut, bolt, and washer combinations to specifications. It is expected that the total clamp load provided by the 10 fasteners utilized will keep the assembly tight, and the two bolts inserted through the alignment holes (here, the holes 142 and 150) will give the joint added shear strength.

Clocking angles in intervals of 2.81° are achievable by varying the hole set used. To produce a clocking angle defined as 2.81° with the torque plate 120A, alignment bolts are passed through the pair of holes 144, 152 (hole set B) in the first torque plate 120A. Similarly, to produce a clocking angle of 5.63° with the torque plate 120A, alignment bolts are passed through the pair of holes 146, 154 (hole set C) in the first torque plate 120A, and to produce a clocking angle of 8.44° with the torque plate 120A, alignment bolts are passed through the pair of holes 148, 156 (hole set D) in the first torque plate 120A.

At this point, for additional increases in the clocking angle, the second torque plate 120B is utilized. To produce a clocking angle of 11.25° with the torque plate 120B, alignment bolts are passed through the pair of holes 142, 150 (hole set E) in the second torque plate 120B. To produce a clocking angle of 14.06° with the torque plate 120B, alignment bolts are passed through the pair of holes 144, 152 (hole set F) in the second torque plate 120B. To produce a clocking angle of 16.88° with the torque plate 120B, alignment bolts are passed through the pair of holes 146, 154 (hole set G) in the second torque plate 120B. Finally, to produce a clocking angle of 19.69° with the torque plate 120B, alignment bolts are passed through the pair of holes 148, 156 (hole set H) in the second torque plate 120B.

Beyond this, the torque plate 120A (and 120B) may once again be utilized to provide larger clocking angles. To accomplish this, the two alignment bolts mentioned are inserted through the torque plate hole set A, but through a different pair of the 16 backing plate holes that are directly adjacent to the original pair of backing plate holes used to provide the 0.00° clocking angle. The series of hole set variations described above can be repeated to produce clocking angles adjusted in 2.81° increments. Any pair of backing plate holes may be utilized as well, permitting effective adjustment of clocking angles from 0.00° to 360.00°.

The following table identifies the torque plate clocking angles obtainable according to the second embodiment of the invention by changing among hole sets A through H and by sequentially utilizing each of the 16 backing plate holes. It will be understood that the angular distance between the centers of all slots is the same as the clocking increment.

| Angle | Hole Set |
|---|---|
| 0.00° | A |
| 2.81° | B |
| 5.63° | C |
| 8.44° | D |
| 11.25° | E |
| 14.06° | F |
| 16.88° | G |
| 19.69° | H |
| 22.50° | A |
| 25.31° | B |
| 28.13° | C |
| 30.94° | D |
| 33.75° | E |
| 36.56° | F |
| 39.38° | G |
| 42.19° | H |
| 45.00° | A |
| 47.81° | B |
| 50.63° | C |
| 53.44° | D |
| 56.25° | E |
| 59.06° | F |
| 61.88° | G |
| 64.69° | H |
| 67.50° | A |
| 70.31° | B |
| 73.13° | C |
| 75.94° | D |
| 78.75° | E |
| 81.56° | F |
| 84.38° | G |
| 87.19° | H |
| 90.00° | A |
| 92.81° | B |
| 95.63° | C |
| 98.44° | D |
| 101.25° | E |
| 104.06° | F |
| 106.88° | G |
| 109.69° | H |
| 112.50° | A |
| 115.31° | B |
| 118.13° | C |
| 120.94° | D |
| 123.75° | E |
| 126.56° | F |
| 129.38° | G |
| 132.19° | H |
| 135.00° | A |
| 137.81° | B |
| 140.63° | C |
| 143.44° | D |
| 146.25° | E |
| 149.06° | F |
| 151.88° | G |
| 154.69° | H |
| 157.50° | A |
| 160.31° | B |
| 163.13° | C |
| 165.94° | D |
| 168.75° | E |
| 171.56° | F |
| 174.38° | G |
| 177.19° | H |
| 180.00° | A |
| 182.81° | B |
| 185.63° | C |
| 188.44° | D |
| 191.25° | E |
| 194.06° | F |
| 196.88° | G |
| 199.69° | H |
| 202.50° | A |
| 205.31° | B |
| 208.13° | C |
| 210.94° | D |
| 213.75° | E |
| 216.56° | F |
| 219.38° | G |
| 222.19° | H |
| 225.00° | A |
| 227.81° | B |
| 230.63° | C |
| 233.44° | D |
| 236.25° | E |
| 239.06° | F |
| 241.88° | G |
| 244.69° | H |
| 247.50° | A |
| 250.31° | B |
| 253.13° | C |
| 255.94° | D |
| 258.75° | E |
| 261.56° | F |
| 264.38° | G |
| 267.19° | H |
| 270.00° | A |
| 272.81° | B |
| 275.63° | C |
| 278.44° | D |
| 281.25° | E |
| 284.06° | F |
| 286.88° | G |
| 289.69° | H |
| 292.50° | A |
| 295.31° | B |
| 298.13° | C |
| 300.94° | D |
| 303.75° | E |
| 306.56° | F |
| 309.38° | G |
| 312.19° | H |
| 315.00° | A |
| 317.81° | B |
| 320.63° | C |
| 323.44° | D |
| 326.25° | E |
| 329.06° | F |
| 331.88° | G |
| 334.69° | H |
| 337.50° | A |
| 340.31° | B |
| 343.13° | C |
| 345.94° | D |
| 348.75° | E |
| 351.56° | F |
| 354.38° | G |
| 357.19° | H |
| 360.00° | A |

The cross sectional view provided by FIG. 14 illustrates a mounting bolt 182 passing through the slot 174 provided in the annular mounting section 34. FIG. 14 also shows the rear face 33 of the annular mounting section 34, against which the mounting face of the axle housing backing plate is to be secured.

FIG. 15 shows the second torque plate 120B after it has been fully mounted to and secured upon an axle housing backing plate 190. As noted above, ten fasteners, such as the mounting bolts 182, are sufficient to securely clamp the torque plate to the backing plate 190.

Prior to use, the carrier and mounting bolt flanges will still need to be machined on both sides. To try to reduce machining costs, however, the torque plate of this invention may have the six carrier bolt holes, the eight mounting holes, and the eight mounting slots cast in with a somewhat smaller size than finally required, and with a three to four degree draft angle. These holes and slots can then be very accurately located and precision punched out to very close tolerances. The punching can be done at once or in phases, depending on the cost versus tonnage relationship. The adaptive torque plates 120A and 120B can be cast from the same set of tools, since the mounting holes and slots are indexed at 11.25° but are otherwise the same. Tooling costs are thus reduced.

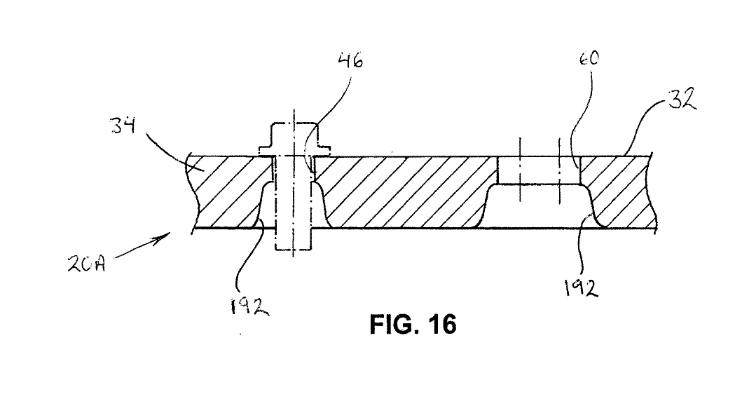

FIG. 16, which is a sectional view along line 16-16 of FIG. 1, shows features serving to facilitate torque plate production. To produce a torque plate according to the invention, such as the torque plate 20A of FIGS. 1-2 and 16, it is contemplated that an overall torque plate blank will be cast, possibly with the slots and holes roughly formed. The holes and slots would then be very precisely cored, stamped, punched, or machined in the casting to produce the final torque plate.

To assist in the coring, stamping, or other procedures, recesses 192 may be cast in or otherwise produced around the holes and slots to minimize the coring or machining time required or the stamping or punching force needed after torque plate casting. Although the torque plates typically have an 18 mm to 20 mm thickness, the recesses 192 serve to reduce this thickness in the vicinities of the holes and slots to approximately 3 mm to 5 mm, permitting easier and faster hole and slot production.

The slots used in the adaptable torque plate arrangements of the present invention make those arrangements more lightweight in addition to providing for rotation of the brake assembly to accommodate available mounting space. Other advantages will result, as the now-available automated punching of holes and slots is faster and less costly, and requires lower tooling capital investment. The use of cored holes and slots rather than holes and slots produced during solid casting could result in an estimated 2.5 lbs. material savings. Pre-made adaptive torque plates can accommodate shortened lead times and virtually eliminate the need for expedited machining and shipping. The plates should result in an attractive cost reduction relative to the cost structure now in place.

OEMs will additionally be permitted to perform their own air disc brake and drum brake installations. The invention should permit reductions in time needed and costs incurred upon making changes to clocking angle requirements when a truck order gets changed while air disc brake assemblies are already in transit to an assembly plant. Aftermarket sales, and possibly military sales, should be facilitated by providing a way to perform efficient air disc brake retro-fitting in the field. The number of torque plates needed is reduced; in the arrangements described, only two or four different torque plates are required. The invention permits the use of various clocking angles needed for new products without requiring new design time. Installation, again, may be performed by the customer.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. An arrangement for securing a carrier for a brake to an axle housing of a vehicle, comprising:
a torque plate including an attachment portion securable to the carrier and an annular mounting section securable to a backing plate on the axle housing,
wherein the annular mounting section is provided with pluralities of alignment holes and mounting slots permitting adjustment of a torque plate clocking angle.

2. The arrangement of claim 1, wherein said torque plate is one of a plurality of interchangeable torque plates providing for adjustment of said clocking angle.

3. The arrangement of claim 2, wherein four of said interchangeable torque plates are utilized to permit clocking angle adjustments from zero degrees to 360 degrees relative to the backing plate.

4. The arrangement of claim 2, wherein no more than two of said interchangeable torque plates are utilized to permit clocking angle adjustments from zero degrees to 360 degrees relative to the backing plate.

5. The arrangement of claim 1, further comprising bolts by which said torque plate is fastenable to the backing plate.

6. The arrangement of claim 1, wherein a maximum of ten of said bolts are used for fastening said torque plate to the backing plate.

7. The arrangement of claim 3, wherein said clocking angle adjustments are available in increments under three degrees.

8. The arrangement of claim 4, wherein said clocking angle adjustments are available in increments under three degrees.

9. The arrangement of claim 3, wherein said alignment holes are circular.

10. The arrangement of claim 9, wherein two pairs of said alignment holes are provided, and each alignment hole has a center circumferentially offset from the center of an adjacent alignment hole by an angle exceeding 22.5 degrees.

11. The arrangement of claim 10, wherein said angle is 25.31 degrees.

12. The arrangement of claim 4, wherein said alignment holes are circular.

13. The arrangement of claim 12, wherein four pairs of alignment holes are provided, and each alignment hole has a center circumferentially offset from the center of an adjacent alignment hole by an angle below 45 degrees.

14. The arrangement of claim 13, wherein said angle is 42.19 degrees.

15. The arrangement of claim 1, wherein adjacent alignment holes are directly adjacent to each other with no slots interposed.

16. The arrangement of claim 1, wherein all adjacent alignment holes have a mounting slot disposed therebetween.

17. The arrangement of claim 1, further comprising an ABS sensor mounting arrangement received in one of the slots.

18. The arrangement of claim 2, wherein each of the interchangeable torque plates includes indicia provided thereto to facilitate torque plate orientation.

19. An adaptive torque plate for securing a carrier for a brake to an axle housing of a vehicle, comprising:
an attachment portion securable to the carrier, and
an annular mounting section securable to a backing plate on the axle housing,
wherein the annular mounting section is provided with pluralities of alignment holes and mounting slots providing for connection of the torque plate to the carrier.

20. The adaptive torque plate of claim 19, wherein adjacent alignment holes are directly adjacent to each other with no slots interposed.

21. The adaptive torque plate of claim 19, wherein all adjacent alignment holes have a mounting slot disposed therebetween.

22. The adaptive torque plate of claim 19, further comprising a pair of connecting sections displaced relative to the annular mounting section by which the torque plate is securable to the carrier.

23. The adaptive torque plate of claim 19, further comprising an ABS sensor mounting arrangement received in one of the slots.

24. A process of making a torque plate for use in an arrangement for securing a carrier for a brake to an axle housing of a vehicle, comprising:
providing a torque plate blank, and
producing pluralities of alignment holes and mounting slots permitting adjustment of a torque plate clocking angle in an annular mounting section of said torque plate blank.

25. The process of claim 24, wherein the alignment holes and mounting slots are produced by at least one of coring, stamping, punching, and machining operations.
